(19) United States
(12) Patent Application Publication
(10) Pub. No.: US 2024/0335865 A1
(43) Pub. Date: Oct. 10, 2024

(54) APPARATUS AND METHOD FOR OPTIMIZED CONDUIT LINE SANITATION

(71) Applicant: Wilson Innovations & Consulting, LLC, Indian Shores, FL (US)

(72) Inventors: Todd S. Wilson, Indian Shores, FL (US); Janet M. Wilson, Indian Shores, FL (US)

(21) Appl. No.: 18/522,498

(22) Filed: Nov. 29, 2023

Related U.S. Application Data
(60) Provisional application No. 63/494,710, filed on Apr. 6, 2023.

(51) Int. Cl. B08B 9/032

(52) U.S. Cl. CPC B08B 9/032; B08B 2209/032; F24F 2013/227; F24F 2221/225

(57) ABSTRACT

Described herein relates to an apparatus and method for optimized dispensing of conduit cleaning agent(s). The apparatus may be configured to dispense cleaning agent(s) (e.g., vinegar and/or acetic acid) into a conduit line (e.g., a condensate drain) at predetermined timed intervals. The apparatus may be adapted for multi-unit dwellings where conduit pathways are shared between different units and air conditioning systems. The apparatus may include a plurality of timer-controlled valves (e.g., motorized valves), which may be synchronized to simultaneously release the cleaning agent(s). Additionally, the apparatus may comprise a reservoir that may gravity feed the cleaning agent(s) into these integrated timer/release valves. As such, activation by the timer may cause the release of the cleaning agent(s) into the conduit line via tubing. Accordingly, the system may be configured to prevent substance accumulation/occlusion in the conduit line of a HVAC, refrigeration, and/or septic system, and/or minimize the need for regular maintenance.

### CROSS-REFERENCE TO RELATED APPLICATIONS

This nonprovisional application claims priority to U.S. Provisional Patent Application No. 63/494,710 entitled “SYSTEM AND METHOD OF SANITIZING CONDENSATE LINES” filed Apr. 6, 2023 by the same inventors, all of which is incorporated herein by reference, in its entirety, for all purposes.

### BACKGROUND OF THE INVENTION

### 1. Field of the Invention

This invention relates, generally, to air conditioning. More specifically, it relates to an apparatus and method for optimized conduit line (e.g., condensate line) sanitation, via dispersion of a predetermined amount of cleaning agent at predetermined intervals for heating, ventilation, and/or air conditioning (hereinafter “HVAC”) systems, refrigeration systems, and/or septic system.

### 2. Brief Description of the Prior Art

Every year millions of dollars are spent to repair the damage done from clogged and overflowing condensate drain lines and pans. The HVAC system produces between five and eight gallons a day of condensate when in operation. If the drain line is clogged, it will not take long to overflow the drain pan and cause considerable damage to flooring, ceiling, and/or carpet, as well as possible damage to adjacent housing units. For example, when the condensate drain line becomes clogged, the condensate will back up behind a mildew, algae, and/or mold plug. Eventually the condensate may leak upstream of the plug, and/or would/will cause water damage to the floor of a housing unit and/or to the ceiling of the adjacent housing units. Although the algae clog can be removed by mechanical means—frequently, by using compressed air to blow the plug to the exterior so that condensate flows freely again—the damage will have been done.

The key to preventing the condensate drain line from clogging or overflowing is having the drain lines treated on a regular basis. However, it can be difficult to actively provide a treatment to the condensate drain line on a regularly scheduled basis. For example, a significant amount of individuals and/or families have second homes for investment and/or vacation properties. As such, this leads to large amounts of absentee ownership for a majority of the year for individual homes. Therefore, it makes it extremely difficult to actively monitor a clog within the condensate drain line and schedule an appropriate maintenance before any damage may occur within the system and/or the overall housing unit.

Additionally, in the United States, more than fifty percent of the population lives within 50 miles of the oceans, and since 1970 there have been approximately 2000 homes per day erected in coastal areas. This means that there is an ever-increasing number of homes which are subjected to high humidity and need algae protection for their air-conditioner condensate drain lines of the HVAC system.

Prior art devices for dealing with the algae build-up in the condensate drain lines of the air-conditioning unit have several limitations. For example, prior art devices do not provide the convenience of a device which includes a housing and/or fluid dispensing mechanism configured to establish a fluidic communication between the condensate line and a cleaning agent. Additionally, devices known in the art are currently unable to selectively control the frequency at which the cleaning agent is transferred into the condensate line and/or control the frequency at which the cleaning agent is transferred into the condensate line of at least one alternative HVAC system.

Accordingly, what is needed is safe, effective, efficient, and easy-to-use system and method for optimized dispersal of cleaning agent into the condensate line of at least one HVAC system. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need, stated above, is now met by a novel and non-obvious invention disclosed and claimed herein. In an aspect, the present disclosure pertains to an apparatus for optimized sanitation of at least one conduit line of a HVAC system, refrigeration system, and/or septic system. In an embodiment, the apparatus may comprise the following: (a) a housing comprising at least one compartment; (b) a reservoir configured to retain at least one cleaning agent; (c) a tubing disposed within the at least one compartment, the tubing being in mechanical communication and/or fluidic communication with the reservoir and/or the at least one conduit line; (d) at least one valve disposed about at least a portion of the tubing, the at least one valve being in mechanical communication with the tubing. In this embodiment, the at least one valve may be configured to release a predetermined amount of the at least one cleaning agent at a predetermined timed interval through the tubing.

In some embodiments, subsequent to the at least one valve releasing the predetermined amount of the at least one cleaning agent, the conduit line of the HVAC system, refrigeration system, and/or septic system may be sanitized. Additionally, the conduit line sanitation apparatus may further comprise a siphon in mechanical communication and/or fluidic communication with the tubing. In these other embodiments, the siphon comprises at least one chamber. In this manner, the at least one chamber may be configured to retain the at least one cleaning agent until a predetermined amount of the at least one cleaning agent may be retained by the at least one chamber, such that the at least one cleaning agent may be released from the siphon into the at least one conduit line. In these other embodiments, the siphon may be a Pythagorean cup, a Pythagorean container, and/or any container known in the art comprising Pythagorean cup-like properties.

In some embodiments, the at least one valve may be motorized. The at least one valve may also comprise at least one actuator configured to translate the valve from an open position to a closed position and/or a closed position to an open position.

In addition, in some embodiments, the conduit line sanitation apparatus may further comprise at least one timer, the at least one timer being communicatively coupled to the at least one motorized valve. In this manner, the at least one timer may be programmable, such that the at least one timer may be configured to receive at least one timed interval input, via a user-interface associated with the at least one timer. In these other embodiments, subsequent to reaching at least one programmed timed interval, the timer may be configured to transmit an electrical signal to the at least one actuator of the at least one motorized valve, such that the at least one motorized valve may be translated from a closed position to an open position, releasing the predetermined amount of the at least one cleaning agent into the conduit line. Accordingly, in these other embodiments, subsequent to the release of the predetermined amount of the at least one cleaning agent into the conduit line, the at least one timer may be configured to cease transmission of the electrical signal to the at least one actuator of the at least one motorized valve, such that the at least one motorized valve may be translated from the open position to the closed position, inhibiting the release of the at least one cleaning agent into the conduit line.

In some embodiments, the conduit line sanitation apparatus may further comprise a protective cover temporarily affixed to the user-interface of the at least one programmable timer, the protective cover being configured to encompass the user-interface.

Moreover, another aspect of the present disclosure pertains to a method for optimizing sanitation of at least one conduit line of an HVAC system, refrigeration system, and/or septic system. In an embodiment, the method may comprise the following steps: (a) disposing at least one cleaning agent into a reservoir in mechanical communication and/or fluidic communication with a tubing, such that the tubing may be in mechanical communication and/or fluidic communication with the at least one conduit line; (b) adjusting at least one valve disposed about at least a portion of the tubing, in which the at least one valve may be in mechanical communication with the tubing; and (c) releasing a predetermined amount of the at least one cleaning agent at a predetermined interval based on the at least one adjusted valve into the at least one conduit line. In this embodiment, the incorporation of the at least one cleaning agent to the conduit line thereof may optimize a sanitizing reaction within the at least one conduit line.

In some embodiments, the tubing may be in mechanical communication and/or fluidic communication with a siphon. In these embodiments, the siphon may comprise at least one chamber. As such, the method may further comprise the step of, filling the at least one cleaning agent within the at least one chamber of the siphon until a predetermined amount of the at least one cleaning agent may be retained by the at least one chamber, such that the at least one chamber may be configured to release at least one cleaning agent from the siphon into the at least one conduit line. Furthermore, in these other embodiments, the siphon may be a Pythagorean cup, a Pythagorean container, and/or any container known in the art comprising Pythagorean cup-like properties.

In some embodiments, the at least one valve may be motorized. In this manner, the step of adjusting the at least one valve may further comprise the step of, translating the at least one valve from an open position to a closed position and/or a closed position to an open position.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a graphical representation depicting a perspective view of a first exemplary embodiment of a conduit line sanitation apparatus, according to an embodiment of the present disclosure.

FIG. 2 is a graphical representation depicting a front view of the first exemplary embodiment of the conduit line sanitation apparatus of FIG. 1, according to an embodiment of the present disclosure.

FIG. 3 is a graphical representation depicting a back view of the first exemplary embodiment of the conduit line sanitation apparatus of FIG. 1, according to an embodiment of the present disclosure.

FIG. 4 is a graphical representation depicting a left-side view of the first exemplary embodiment of the conduit line sanitation apparatus of FIG. 1, according to an embodiment of the present disclosure.

FIG. 5 is a graphical representation depicting a right-side view of the first exemplary embodiment of the conduit line sanitation apparatus of FIG. 1, according to an embodiment of the present disclosure.

FIG. 6 is a graphical representation depicting a top view of the first exemplary embodiment of the conduit line sanitation apparatus of FIG. 1, according to an embodiment of the present disclosure.

FIG. 7 is a graphical representation depicting a bottom view of the first exemplary embodiment of the conduit line sanitation apparatus of FIG. 1, according to an embodiment of the present disclosure.

FIG. 8 is a graphical representation depicting a front view of an internal chamber of the first exemplary embodiment of the conduit line sanitation apparatus of FIG. 1, according to an embodiment of the present disclosure.

FIG. 9 is a graphical representation depicting a perspective view of the first exemplary embodiment of the conduit line sanitation apparatus of FIG. 1 in mechanical communication and/or fluidic communication with at least one conduit line, according to an embodiment of the present disclosure.

FIG. 10 is a graphical representation depicting a perspective view of a second exemplary embodiment of a conduit line sanitation apparatus, according to an embodiment of the present disclosure.

FIG. 11 is a graphical representation depicting a front view of the second exemplary embodiment of the conduit line sanitation apparatus of FIG. 10, according to an embodiment of the present disclosure.

FIG. 12 is a graphical representation depicting a back view of the second exemplary embodiment of the conduit line sanitation apparatus of FIG. 10, according to an embodiment of the present disclosure.

FIG. 13 is a graphical representation depicting a left-side view of the second exemplary embodiment of the conduit line sanitation apparatus of FIG. 10, according to an embodiment of the present disclosure.

FIG. 14 is a graphical representation depicting a right-side view of the second exemplary embodiment of the conduit line sanitation apparatus of FIG. 10, according to an embodiment of the present disclosure.

FIG. 15 is a graphical representation depicting a top view of the second exemplary embodiment of the conduit line sanitation apparatus of FIG. 10, according to an embodiment of the present disclosure.

FIG. 16 is a graphical representation depicting a bottom view of the second exemplary embodiment of the conduit line sanitation apparatus of FIG. 10, according to an embodiment of the present disclosure.

FIG. 17 is a graphical representation depicting a front view of an internal chamber of the second exemplary embodiment of the conduit line sanitation apparatus of FIG. 10, according to an embodiment of the present disclosure.

FIG. 18 is a graphical representation depicting a perspective view of the second exemplary embodiment of the conduit line sanitation apparatus of FIG. 10 in mechanical communication and/or fluidic communication with at least one conduit line, according to an embodiment of the present disclosure.

FIG. 19 is a graphical representation depicting a perspective view of the first exemplary embodiment of the conduit line sanitation apparatus of FIG. 1 comprising a reservoir casing, according to an embodiment of the present disclosure.

FIG. 20 is a flow chart depicting the steps of an exemplary method of sanitizing at least one conduit line, via a conduit line sanitation apparatus, according to an embodiment of the present disclosure.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention.

As such, elements/components shown in diagrams are illustrative of exemplary embodiments of the disclosure and are meant to avoid obscuring the disclosure. Any headings, used herein, are for organizational purposes only and shall not be used to limit the scope of the description or the claims.

Furthermore, the use of certain terms in various places in the specification, described herein, are for illustration and should not be construed as limiting. For example, any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Therefore, a reference to first and/or second elements does not mean that only two elements may be employed there or that the first element must precede the second element in some manner. Also, unless stated otherwise a set of elements may comprise one or more elements

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

Referring in general to the following description and accompanying drawings, various embodiments of the present disclosure are illustrated to show its structure and method of operation. Common elements of the illustrated embodiments may be designated with similar reference numerals.

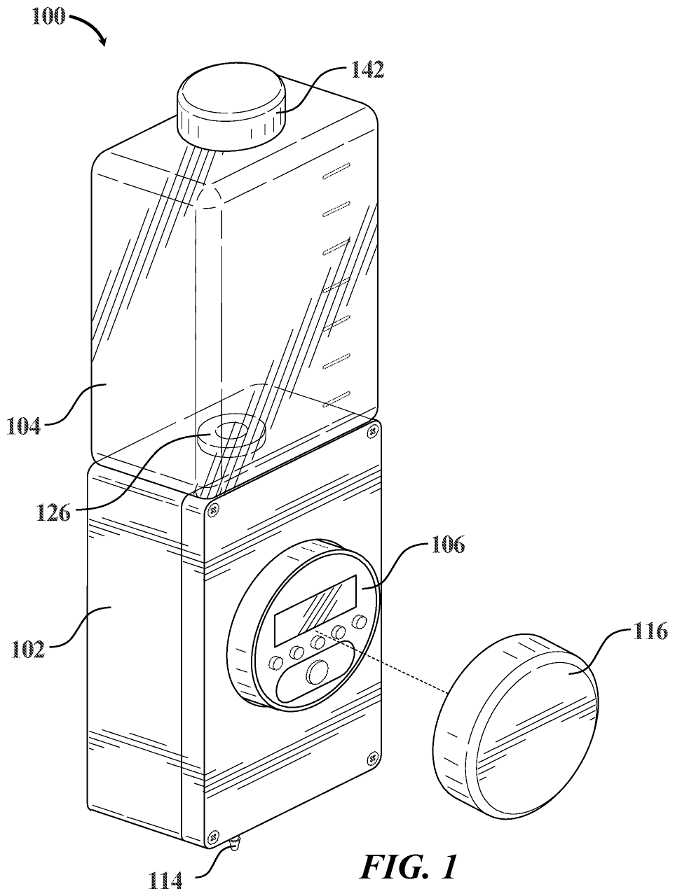

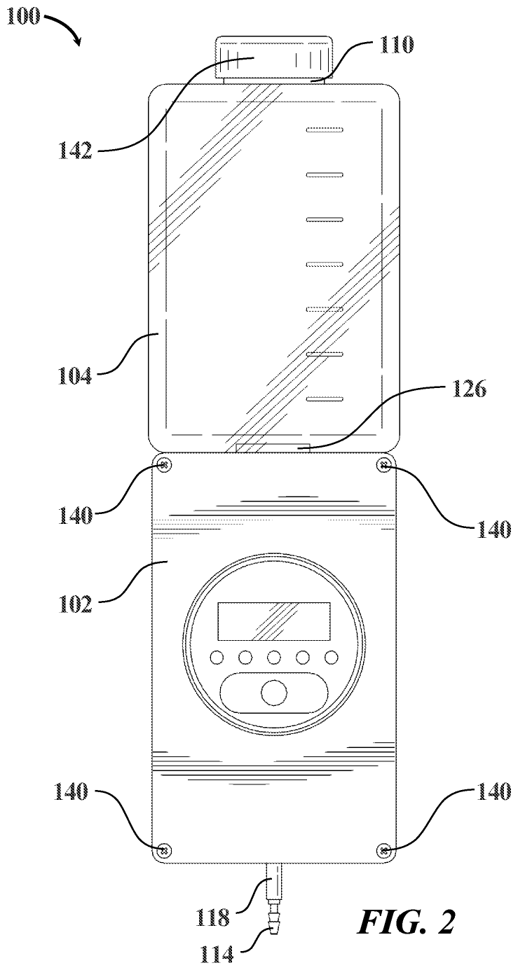

Accordingly, the relevant descriptions of such features apply equally to the features and related components among all the drawings. For example, any suitable combination of the features, and variations of the same, described with components illustrated in FIG. 1, can be employed with the components of FIG. 2, and vice versa. This pattern of disclosure applies equally to further embodiments depicted in subsequent figures and described hereinafter. It should be understood that the figures presented are not meant to be illustrative of actual views of any particular portion of the actual structure or method but are merely idealized representations employed to more clearly and fully depict the present invention defined by the claims below.

### Definitions

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

In the following description, for the purposes of explanation, numerous specific details are set forth in order to provide a thorough understanding of embodiments of the present technology. It will be apparent, however, to one skilled in the art that embodiments of the present technology may be practiced without some of these specific details. The techniques introduced here can be embodied as special-purpose hardware (e.g. circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compacts disc read-only memories (CD-ROMs), magneto-optical disks, ROMS, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

As used herein, the term “cleaning agent” refers to any chemical compound and/or material known in the art configured to dissolve and/or eliminate an occlusion (e.g., algae, mildew, calcium, and/or mold) known in the art. Non-limiting examples of the cleaning agent may be vinegar, acetic acid, bleach, chlorine, hot water, and/or hydrogen peroxide. For ease of reference, the exemplary embodiment described herein refers to vinegar and/or acetic acid, but this description should not be interpreted as exclusionary of other chemical compounds and/or chemical materials.

As used herein, the term “conduit line” refers to any channel (e.g., pipe, hose, tubing) known in the art configured to convey, translate, and/or hold a fluid. Non-limiting examples of the conduit line may be a metal (e.g., steel and/or copper) pipe, metal tubing, metal hose, PVC pipe, PVC tubing, PVC hose, condensate line, condensate tubing, condensate hose, drain line, drain pipe, drain tubing, drain sump, septic drain field, leech leach field, and/or drain hose. For ease of reference, the exemplary embodiment described herein refers to a condensate line and/or a drain line, but this description should not be interpreted as exclusionary of other pipes, tubing, and/or hoses.

As used herein, the term “communicatively coupled” refers to any coupling mechanism configured to exchange information (e.g., at least one electrical signal) using methods and devices known in the art. Non-limiting examples of communicatively coupling may include Wi-Fi, Bluetooth, wired connections, wireless connection, quantum, and/or magnets. For ease of reference, the exemplary embodiment described herein refers to Wi-Fi and/or Bluetooth, but this description should not be interpreted as exclusionary of other electrical coupling mechanisms.

As used herein, the term “mechanical communication” refers to any coupling mechanism configured to transmit and/or transfer any force known in the art using any methods and/or device known in the art. Non-limiting examples of mechanical communication may include mechanical coupling, clamps, gear drives, gear shafts, drive shaft, universal joint, sleeve coupling, roller chain coupling, flange coupling, Oldham coupling, Split Muff coupling, and/or flange coupling. For ease of reference, the exemplary embodiment described herein refers to mechanical coupling, but this description should not be interpreted as exclusionary of other mechanical coupling mechanisms.

As used herein, the term “fluidic communication” refers to any coupling mechanism known in the art configured to transmit and/or transfer any fluid known in the art using any methods and/or device known in the art. Non-limiting examples of fluidic communication may include fluidic coupling, via tubing, a tubing nipple, a tubing barb, a plumbing connector, a plumbing fitting, a fluid clamp, a valve, a pinch valve, a pressure valve, and/or a pressure coupling. For ease of reference, the exemplary embodiment described herein refers to fluidic coupling in tubing, via tubing nipples, tubing barbs, and/or valves, but this description should not be interpreted as exclusionary of other fluidic coupling mechanisms.

As used herein, the term “coupling mechanism” may refer to any apparatus known in the art configured to temporarily affix one object to at least one alternative object. Non-limiting examples of the coupling mechanism may include a screw, a nail, a rivet, a magnet, an adhesive, a tubing nipple, a tubing barb, a hose nipple, a hose barb, a plumbing connector, a plumbing fitting, a fluid clamp, a valve, a pinch valve, a pressure valve, and/or a pressure coupling. For ease of reference, the exemplary embodiment described herein refers to a tubing nipple, a tubing barb, a hose nipple, and/or a hose barb, but this description should not be interpreted as exclusionary of other coupling mechanisms.

As used herein, the term “actuator” refers to any motor known in the art configured to drive movement (e.g., linear movement and/or rotational movement). Non-limiting examples of the actuator may include a stepper motor comprising at least 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, and/or 30 degrees per step, a brushed and/or brushless AC motor, a brushed and/or brushless DC motor, a AC induction motor, and/or a DC servo motor. For ease of reference, the exemplary embodiment described herein refers to a stepper motor, but this description should not be interpreted as exclusionary of other motors configured to drive movement.

As used herein, the terms “about,” “approximately,” or “roughly” refer to being within an acceptable error range (i.e., tolerance) for the particular value as determined by one of ordinary skill in the art, which will depend in part on how the value is measured or determined (e.g., the limitations of a measurement system), (e.g., the degree of precision required for a particular purpose, such as dispensing a predetermined amount of cleaning agent into a HVAC conduit at predetermined intervals of time). As used herein, “about,” “approximately,” or “roughly” refer to within +25% of the numerical.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about”. It is also to be understood, even if it is not always explicitly stated, that the compounds and structures described herein are merely exemplary and that equivalents of such are known in the art and can be substituted for the compounds and structures explicitly stated herein.

Wherever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of two or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

### Conduit Line Sanitation Apparatus

The present disclosure pertains to an apparatus (hereinafter “conduit line sanitation apparatus”) and method for optimized conduit line sanitation, via dispersion of a predetermined amount of cleaning agent (e.g., vinegar and/or acetic acid) at predetermined intervals for heating, ventilation, and/or air conditioning (hereinafter “HVAC”) systems, refrigeration system, septic systems, and/or any system comprising at least one conduit line (e.g., a condensate line of the HVAC system, refrigeration system, and/or septic system).

The conduit line sanitation apparatus may be configured to release a predetermined amount of at least one cleaning agent (e.g., vinegar and/or acetic acid) into at least one conduit line of the HVAC system, refrigeration system, and/or septic system at predetermined timed intervals. As such, the conduit line sanitation apparatus may be configured to remove and/or eliminate any form of occlusion (i.e., build-up and/or blockage) (e.g., mildew, algae, mold, and/or etc.), in addition to preventing any new form of occlusion from occurring within the at least one conduit line, optimizing sanitation and/or performance of the at least one conduit line. In this embodiment, the conduit line sanitation apparatus may comprise at least one valve configured to release the predetermined amount of cleaning agent (e.g., at least 60 ml (0.25 cup)) from the reservoir into the at least one conduit line. For example, in some embodiments, the at least one valve may be configured to release at least 40 mL of the at least one cleaning agent, based on the schematics of the at least one conduit line and/or the density and/or size of the occlusion within the at least one conduit line.

Additionally, in an embodiment, the conduit line sanitation apparatus may include at least one fluid sensor. The at least one fluid sensor may be any detector known in the art configured to determine a flow of the at least one cleaning agent and/or an amount of the at least one cleaning agent released and/or remaining within the reservoir. In this manner, the conduit line sanitation apparatus may comprise at least one processor configured to be communicatively coupled to the at least one fluid sensor. Moreover, the conduit line sanitation apparatus may comprise a wireless (e.g., Wi-Fi and/or Bluetooth) access point, in order to allow communication between the conduit line sanitation apparatus and at least one alternative conduit line sanitation apparatus within the same building unit and/or housing unit and/or between the conduit line sanitation apparatus and at least one external computing device.

The system and method will be described in greater detail in the sections herein below.

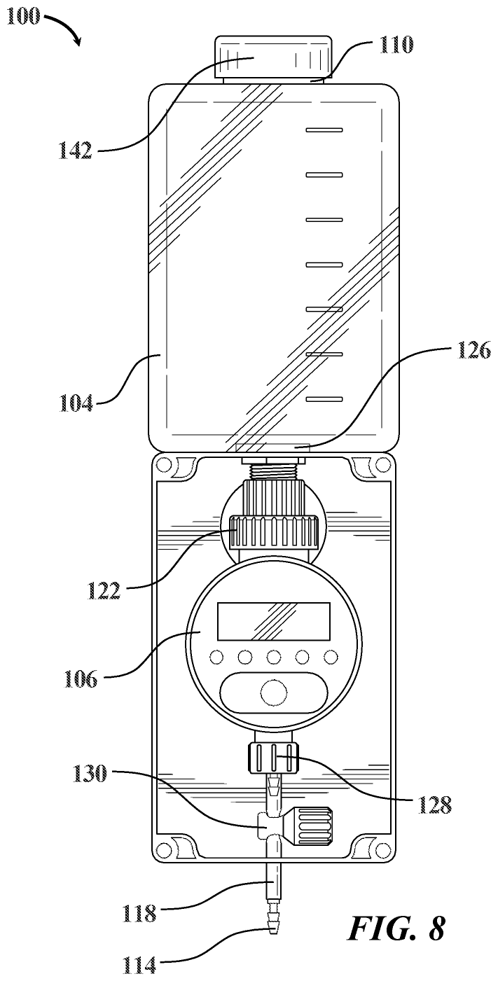

In an aspect, the present disclosure pertains to a conduit line sanitation apparatus 100 configured to actively feed the at least one cleaning agent into the at least one conduit line. FIG. 1, in conjunction with FIGS. 2-9, depicts conduit line sanitation apparatus 100, according to an embodiment of the present disclosure. In an embodiment, conduit line sanitation apparatus 100 may comprise a housing 102. In this manner, reservoir 104 may be in mechanical communication with housing 102, such that the reservoir 104 may be temporarily affixed to at least one portion of housing 102. In this embodiment, reservoir may be disposed about a top surface of housing 102. Additionally, as shown in FIG. 1, conduit line sanitation apparatus 100 may comprise a programmable timer 106. In this manner, as shown in FIG. 1, in conjunction with FIG. 8, programmable timer 106 may be communicatively coupled to at least one active (e.g., motorized) valve (hereinafter “programmable timer valve 106”). In some embodiments, the at least one active valve may also be integrated within programmable timer valve 106. In this manner, reservoir 104 may be in fluidic communication with programmable timer valve 106, via at least one aperture (e.g., a bulkhead fitting) 126 disposed about at least a portion of a base of reservoir 104.

In an embodiment, conduit line sanitation apparatus 100 may comprise at least one processor communicatively coupled to programmable timer valve 106 and/or the at least one active valve of programmable timer valve 106. In this embodiment, as shown in FIG. 1 and FIG. 2, programmable timer valve 106 may comprise at least one user-interface configured to receive an input from at least one user. Additionally, in some embodiments, as shown in FIG. 1, programmable timer valve 106 may comprise a protective cover 116, such that protective cover 116 may be configured to be temporarily affixed to a surface of programmable timer valve 106. In this manner, protective cover 116 may encompass the surface of programmable timer valve 106 comprising the user-interface.

In addition, as shown in FIG. 1, in this embodiment, the at least one cleaning agent may be disposed within reservoir 104 via at least one opening 110. The at least one opening 110 may be disposed about at least a portion of a top surface of reservoir 104. In this manner, as shown in FIGS. 1-9, reservoir 104 may comprise at least one cap 142 configured to temporarily couple (e.g., male-to-female threading, adhesives, nails, clasps, and/or steps) to at least one opening 110. In this embodiment, an inner perimeter of at least one cap 142 may be configured to abut an outer perimeter of at least one opening 110, such that the inner perimeter of the at least one cap 142 encompasses at least one opening 110, forming a water tight seal and/or preventing the at least one cleaning agent from escaping reservoir 104. In addition, in some embodiments, at least one cap 142 may comprise at least one hole disposed about at least one portion of a top surface of at least one cap 142, in which the at least one hole may extend through the top surface of the at least one cap 142. Accordingly, in these other embodiments, the at least one hole may be configured to allow the transfer of at least one air particle through reservoir 104 to an external environment and/or vice versa, allowing for the case of flow of the at least one cleaning agent through at least one aperture 126. Moreover, the at least one hole may comprise a size and/or shape configured to retain the at least one cleaning agent within reservoir 104. Furthermore, in these other embodiments, the at least one hole may comprise a mesh, preventing any foreign particulate and/or external moisture and/or external liquid may enter reservoir 104, while at least one cap 142 is temporarily coupled to at least one opening 110.

As shown in FIGS. 1-3, in conjunction with FIGS. 8, reservoir 104 may comprise a plurality of measurement markings, such that the total amount of cleaning agent within reservoir 104 may be determined by at least one user, via a visual stimulus and/or a tactile stimulus. In this manner, in some embodiments, reservoir 104 may comprise at least one illuminator (e.g., an LED light) configured to highlight and/or illuminate the plurality of measurement markings. The at least one illuminator may be disposed about at least one portion of an internal surface of reservoir 104 and/or a bottom surface of at least one cap 142. In these other embodiments, the at least one illuminator may also be communicatively coupled to the at least one processor of conduit line sanitation apparatus 100, such that the at least one user may activate and/or program the at least one illuminator. Accordingly, when the at least one user interacts with the at least one user interface of programmable timer valve 106, the at least one processor may be configured to transmit an electrical signal to the at least one illuminator, such that the at least one illuminator may be configured to activate for a predetermined amount of time, highlighting and/or illuminating the plurality of measurement markings. In this manner, the at least one user may then be able to determine an amount of the at least one cleaning agent remaining in reservoir 104 as compared to the plurality of measurement markings.

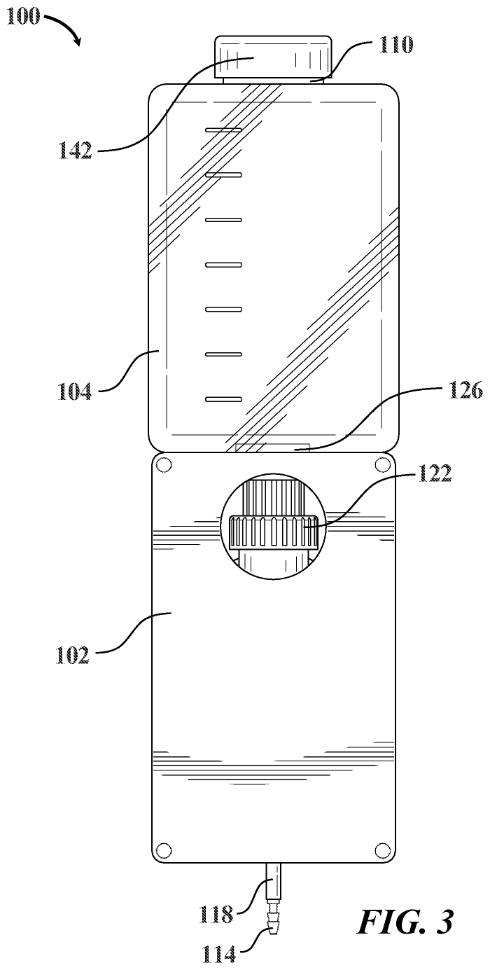

As shown in FIG. 2 and FIG. 3, in conjunction with FIG. 8, housing 102 may comprise at least one chamber, such that the at least one active valve of programmable timer valve 106 may be disposed in the at least one chamber of housing 102. In addition, at least one reservoir valve connector 122 may be disposed within the at least one chamber. As such, in this embodiment, at least one reservoir valve connector 122 may be in fluidic communication with programmable timer valve 106, such that at least one reservoir valve connector 122 may release the at least one cleaning agent from reservoir 104 toward programmable timer valve 106 at a predetermined amount and/or a predetermined rate (e.g., at least 60 mL (0.25 cups) per day, week, and/or month. For example, in some embodiments, at least one reservoir valve connector 122, via programmable timer valve 106, may be configured to vary the predetermined amount and/or the predetermined rate of release of the at least one cleaning solution based on an amount of occlusion found in the at least conduit line and/or a time of the year. Accordingly, in an embodiment, when the at least one cleaning agent is received by programmable timer valve 106, programmable timer valve 106 may be configured to release the at least one cleaning agent into the at least one conduit line.

Additionally, as shown in FIG. 2 and FIG. 3, in conjunction with FIG. 8, in an embodiment, a tubing 118 may be disposed within the at least one chamber of housing, such that one end of tubing 118 may be in mechanical communication and/or fluidic communication with reservoir 104, programmable timer valve 106, and/or at least one reservoir valve connector 122. In this manner, in this embodiment, the opposite end of tubing 118 may be in mechanical communication and/or fluidic communication with a first coupling mechanism (e.g., a tubing nipple and/or a hose barb) 114. First coupling mechanism 114 may be configured to mechanically couple and/or fluidly couple with at least one conduit line, such that once the at least one cleaning agent is released from the conduit line sanitation apparatus, via reservoir 104 and/or programmable timer valve 106, the at least one cleaning agent may enter the at least one conduit line.

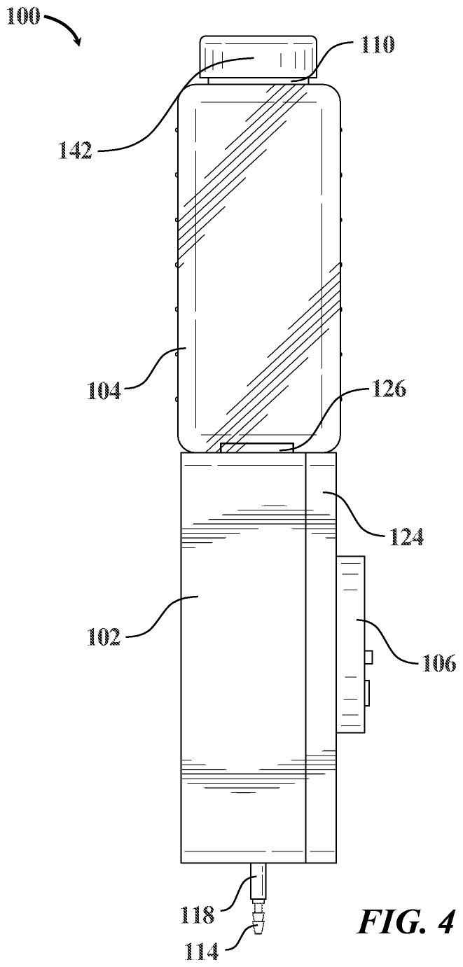

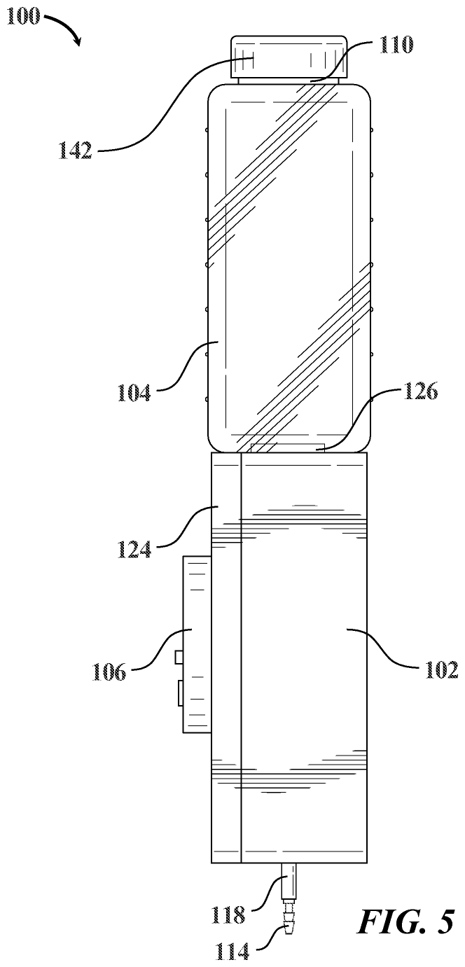

FIG. 4 and FIG. 5 depict a side perspective of conduit line sanitation apparatus 100, according to an embodiment of the present disclosure. In an embodiment, housing 102 may comprise a lid 124 disposed about at least a portion of the front side of housing 102. In this manner, lid 124 may be configured to be removably affixed to the front side of housing 102, such that when lid 124 is removed, the at least one chamber of housing 102 may be exposed. Accordingly, lid 124 may comprise a first opening, such that lid 124 may be configured to abut an outer perimeter of programmable timer valve 106. In this embodiment, when lid 124 is removably affixed to housing 102, via at least one connector 140 (e.g., a screw, a nail and/or an adhesive), the user-interface of programmable timer valve 106 may be exposed such that a user may provide an input to the user-interface. In this manner, as stated above, lid 124 may be mechanically coupled to housing 102, via at least one coupling mechanism 140 (e.g., at least one screw).

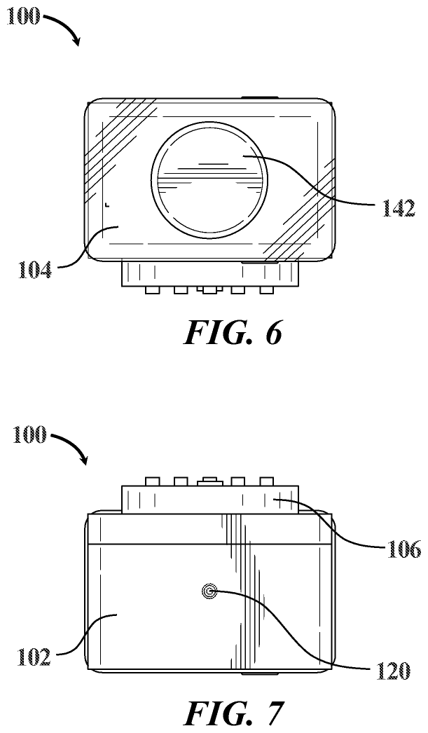

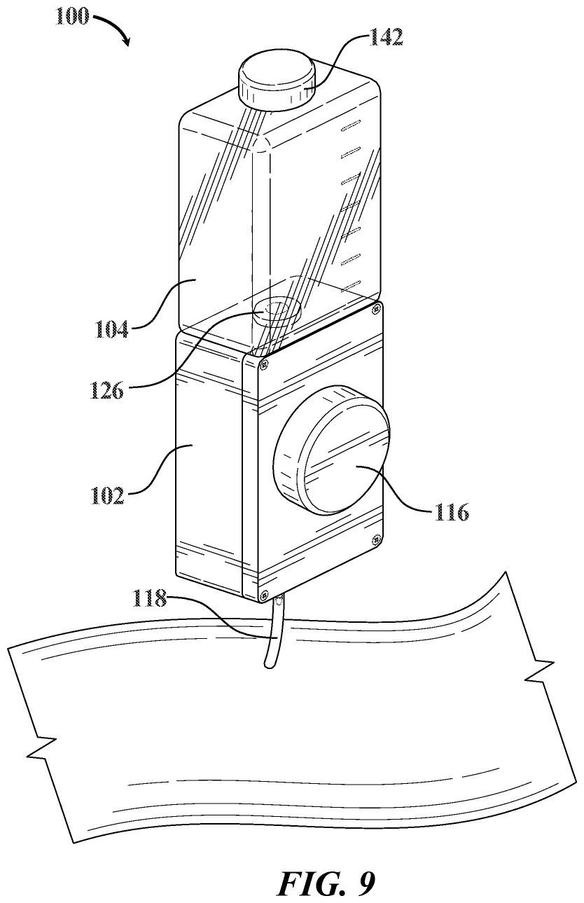

Additionally, as shown in FIG. 6 and FIG. 7, in conjunction with FIG. 8 and FIG. 9, as stated above, reservoir 104 may comprise at least one opening 110 disposed about the top surface of reservoir 104. In this manner, the at least one cleaning agent may be disposed and/or poured into reservoir 104, via the at least one opening 110. Additionally, as shown in FIG. 7, housing 102 of conduit line sanitation apparatus 100 may comprise at least one orifice 120, such that tubing 118 may be disposed through at least one orifice 120. As such, an inner perimeter of at least one orifice 120 may be configured to abut an outer perimeter of tubing 118, such that the inner perimeter of at least one orifice 120 may encompass the outer perimeter of tubing 118, forming a water tight seal. In this manner, in this embodiment, tubing 118 may be disposed both within the at least one chamber and outside the housing 102, via at least one orifice 120.

In an embodiment, as shown in FIG. 8, in conjunction with FIGS. 1-7 and FIG. 9, conduit line sanitation apparatus may further comprise at least one crimp 130 (e.g., a pressure valve, a pinch valve, and/or any valve known in the art comprising pressure valve and/or pinch valve-like properties). in mechanical communication with tubing 118. In this manner, at least one crimp 130 may be disposed about at least a portion of tubing 118 subsequent to programmable timer valve 106. As such, at least one crimp 130 may be configured to provide a force to the perimeter of tubing 118, such that the rate of flow within tubing 118 may be increased and/or decreased, based on the amount of force exerted by the at least one crimp 130 (e.g., a pressure valve, a pinch valve, and/or any valve known in the art comprising pressure valve and/or pinch valve-like properties). As such, the rate of release of the at least one cleaning agent may be slowed based on the exact specifications provided by the HVAC system, refrigeration system, and/or septic system connected to the conduit line. Accordingly, an appropriate amount of the at least one cleaning agent may be disposed within the at least one conduit line at a predetermined time, via programmable timer valve 106 and/or at least one crimp 130, such that the occlusion within the at least one conduit line may be eliminated (e.g., dissolved) and/or prevented, freeing the at least one conduit line of any occlusion (e.g., algae buildup, mildew buildup, and/or mold buildup).

In addition, shown in FIG. 8, in an embodiment, programmable timer valve 106 may be in mechanical communication and/or fluidic communication with tubing 118, via a second coupling mechanism 128 (e.g., a tubing nipple and/or a hose barb), such that a water tight seal may be formed between programmable timer valve 106 and tubing 118. As such, when programmable timer valve 106 releases the predetermined amount of the at least one cleaning agent at the designated timing interval, the at least one cleaning agent may pass into tubing 118 without loss of any cleaning agent, via second coupling mechanism 128.

Additionally, as shown in FIGS. 1-9, in an embodiment, conduit line sanitation apparatus 100 may comprise at least one fluid sensor (not shown), such that the amount of the at least one cleaning agent disposed within reservoir 104, tubing 118, and/or programmable timer valve 106 may be determined. In this manner, in this embodiment, programmable timer valve 106 may comprise at least one actuator (not shown) in mechanical communication with the at least one active valve (not shown) of programmable timer valve 106. The at least one actuator may be configured to translate the at least one active valve of programmable timer valve 106 to the open position (i.e., free flow of the at least one cleaning agent through tubing 118) and/or the closed position (i.e., inhibiting the flow of the at least one cleaning agent through tubing 118). Therefore, in this embodiment, the at least one fluid sensor may also be communicatively coupled to programmable timer valve 106. In this manner, the at least one fluid sensor may be configured to determine a fluid flow rate and/or a total amount of the at least one cleaning agent traveling through tubing 118.

As such, in an embodiment, when the at least one fluid sensor determines that the fluid flow rate and/or the total amount of the at least one cleaning agent is too great as compared to a predetermined fluid flow rate and/or predetermined amount released, the at least one fluid sensor may be configured to transmit at least one electrical signal to the processor. In this embodiment, subsequent to receiving the at least one electrical signal, the processor may be configured to transmit at least one electrical signal to programmable timer/valve 106, such that the at least one actuator may be activated, translating the at least one active valve of programmable timer valve 106 to the closed position. In this same manner, when the at least one fluid sensor determines that the fluid flow rate and/or the total amount of the at least one cleaning agent is too low as compared to a predetermined fluid flow rate and/or predetermined amount released, the at least one fluid sensor may be configured to transmit at least one alternative electrical signal to the processor.

In this embodiment, subsequent to receiving the at least one alternative electrical signal, the processor may be configured to transmit the at least one electrical signal to programmable timer valve 106, such that the at least one actuator may be activated, translating the at least one active valve of programmable timer valve 106 to the open position from the closed position. In some embodiments, the at least one actuator may be configured to translate the at least one valve to a position between the open position and the closed position, such that the flow rate of the at least one cleaning agent may be adjusted accordingly (e.g., half way between the open position and the closed position, such that the fluid flow rate is reduced by half). Accordingly, in these other embodiments, the at least one processor may be configured to continuously transfer an electrical signal to the at least one actuator, such that the position of the at least one valve may be automatically adjusted accordingly, such that the predetermined amount of cleaning agent and/or the predetermined rate of flow may be maintained, as detected by the at least one fluid sensor.

Moreover, in an embodiment, at least one fluid sensor may be configured to transmit at least one electrical signal to the at least one processor associated with conduit line sanitation apparatus 100 once a predetermined amount and/or level is detected within reservoir 104 (e.g., at most ¼^{th} of the reservoir filled with the at least one cleaning agent). As such, in this embodiment, when the predetermined amount and/or level of is detected, the at least one fluid sensor may be configured to transmit a signal to a display device associated with a computing device communicatively coupled to conduit line sanitation apparatus 100. In addition, in this embodiment, when the at least one electrical signal is received by the computing device, the display device may be configured to transmit a signal to the at least one user indicative of a low amount of cleaning agent remaining within reservoir 104 and/or indicative of having to refill reservoir 104.

In an embodiment, the at least one processor of conduit line sanitation apparatus 100 may also be in communication with the user-interface of programmable timer valve 106. As such, the user-interface of programmable timer valve 106 may be configured to allow the at least one user to input a predetermined amount of the at least one cleaning agent to be released and/or the predetermined rate of flow for the at least one cleaning agent into the at least one conduit line. Additionally, as stated above, the at least one processor may be communicatively coupled to the at least one external computing device (e.g., a mobile phone, a smartphone, a laptop, and/or a tablet), such that the at least one external computing device may be configured to allow the at least one user to input the predetermined amount of the at least one cleaning and/or the predetermined rate of flow for the at least one cleaning agent. In this manner, in some embodiments, the at least one processor may be configured to allow the at least one user to input the activation of the at least one illuminator for the predetermined amount of time, via the at least one external computing device.

Accordingly, in this embodiment, when the at least one user inputs the predetermined amount and/or the predetermined rate of flow, via the user-interface and/or the at least one external computing device, programmable timer valve 106 may be configured to transmit an electrical signal to the at least one processor. In this manner, as stated above, in this embodiment, subsequent to receiving the at least one alternative electrical signal, the processor may be configured to transmit the at least one electrical signal to programmable timer valve 106, such that the at least one actuator may be activated, translating the at least one active valve of programmable timer valve 106 to the open position from the closed position. Accordingly, in this embodiment, the at least one processor may be configured to continuously transfer an electrical signal to the at least one actuator, such that the position of the at least one valve may be automatically adjusted accordingly, such that the predetermined amount of cleaning agent and/or the predetermined rate of flow, as provided by the at least one user, may be maintained.

As stated above, another feature of the present disclosure is that conduit line sanitation apparatus 100 may comprise the wireless (e.g., Wi-Fi and/or Bluetooth access point) access point, such that conduit line sanitation apparatus 100 may be configured to communicatively couple with at least one alternative conduit line sanitation apparatus within a same building unit and/or housing unit. In this manner, the conduit line sanitation apparatus 100 and the at least one alternative conduit line sanitation apparatus may be configured to synch the release of the at least one cleaning agent into the at least one conduit line (e.g., condensate line) of the HVAC system, refrigeration system, and/or septic system, to allow for constant and/or optimized removal and/or sanitation of any occlusion within the at least one conduit line of the HVAC system, refrigeration system, and/or septic system of the building unit and/or housing unit.

Moreover, in this embodiment the wireless access point may be communicatively coupled to the computing device associated with conduit line sanitation apparatus 100 and/or the at least one alternative conduit line sanitation apparatus. Accordingly, the computing device may be configured to transmit at least one electrical signal to the processor of the conduit line sanitation apparatus 100 and/or the at least one alternative conduit line sanitation apparatus to synchronize both apparatuses. Additionally, the computing device may be configured to monitor the level of the at least one cleaning agent within conduit line sanitation apparatus 100 and/or the at least one alternative conduit line sanitation apparatus to determine when levels are too low and may require refilling. Moreover, the computing device may be configured to select individual conduit line sanitation apparatuses within the building unit to individually release the at least one cleaning agent at the associated conduit line for the selected conduit line sanitation apparatus 100 based on the level of occlusion within the associated conduit line of the selected conduit line sanitation apparatus 100.

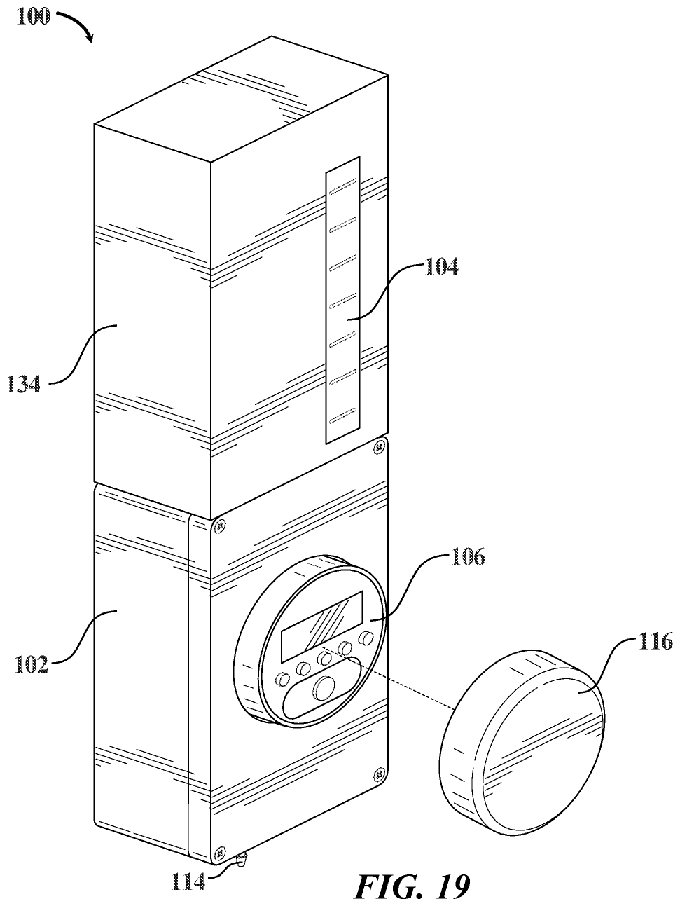

Furthermore, as shown in FIG. 19, in conjunction with FIG. 1, in an embodiment, conduit line sanitation apparatus 100 may comprise a reservoir casing 134. Reservoir casing 134 may be configured to encompass reservoir 104, such that the base of reservoir casing 134 may abut the top surface of housing 102. In this manner, reservoir casing 134 may also comprise an opening, such that when reservoir casing 134 encompasses reservoir 104, the plurality of measurement marking may be seen. In some embodiments, the plurality of measurement markings may be disposed about at least one portion of reservoir casing 134, such that the total amount of cleaning agent within reservoir 104 may be determined by at least one user, via a visual stimulus and/or a tactile stimulus. In addition, in some embodiments, reservoir casing 134 may be affixed to housing 102, such that reservoir 104 may be encapsulated by reservoir casing 134 and/or housing 102. In these other embodiments, reservoir casing 134 may comprise at least one additional aperture, such that the at least one opening 110 of reservoir 104 may be exposed, allowing the disposal of the at least one cleaning agent into reservoir 104.

An additional aspect of the present disclosure pertains to a conduit line sanitation apparatus 200 configured to passively feed (e.g., gravitationally feed) the at least one cleaning agent into the at least one conduit line.

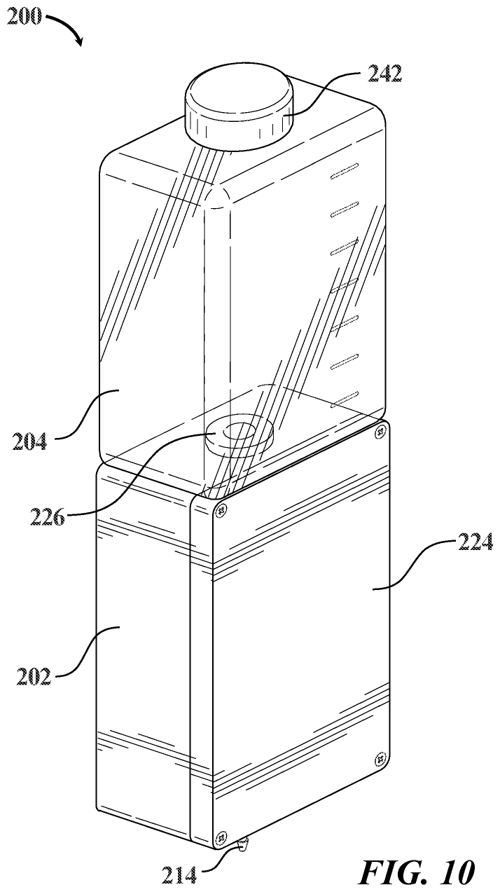

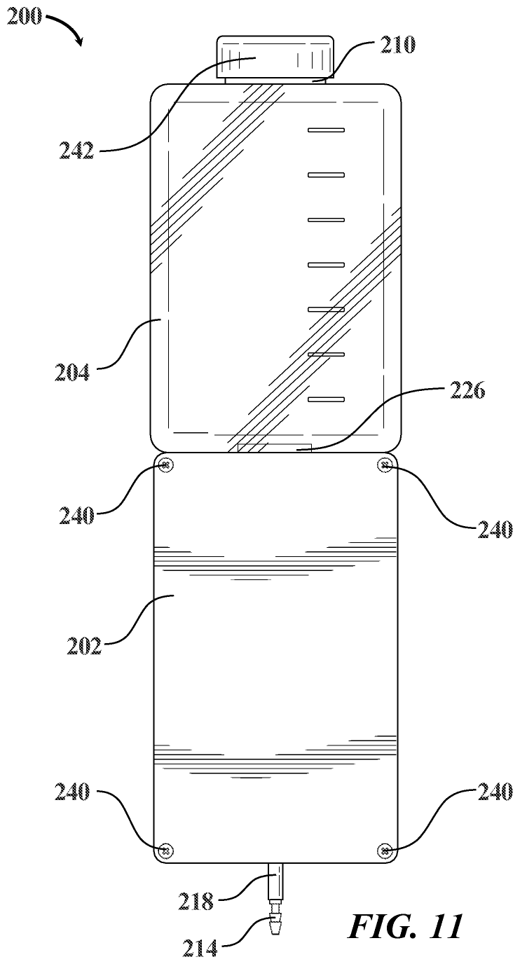

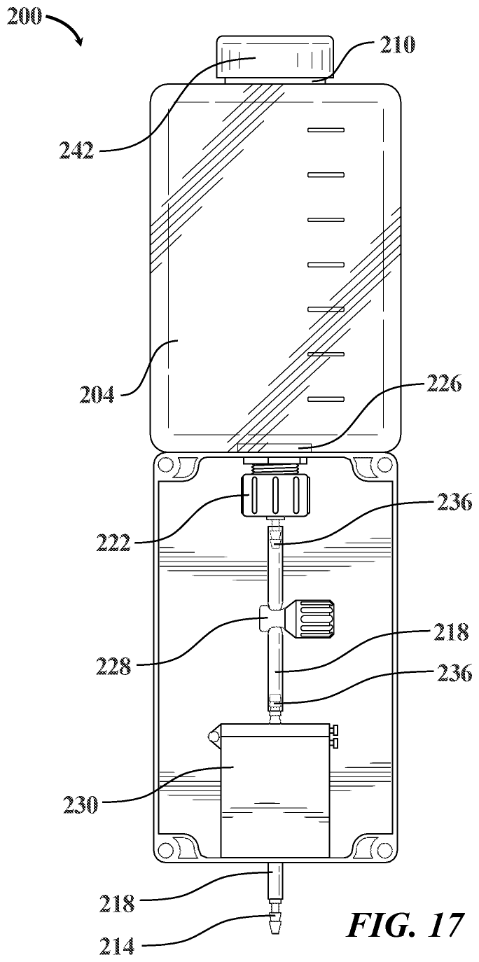

FIG. 10, in conjunction with FIGS. 11-18, depicts conduit line sanitation apparatus 200, according to an embodiment of the present disclosure. In an embodiment, conduit line sanitation apparatus 200 may comprise a housing 202. In this manner, reservoir 204 may in mechanical communication with housing 202, such that the reservoir 204 may be temporarily affixed to at least one portion of housing 202. In this embodiment, reservoir may be disposed about a top surface of housing 202. Additionally, as shown in FIG. 10, in conjunction with FIG. 17, conduit line sanitation apparatus 200 may comprise at least one valve 228. In this manner, as shown in FIG. 10, in conjunction with FIG. 17, at least one valve 228 may be configured to passively feed (e.g., gravitationally feed) the at least one cleaning agent into tubing 218, via a predetermined flow rate (i.e., based on a predetermined positioning of at least one valve 228). In addition, at least one valve 228 may be disposed about at least a portion of tubing 218 subsequent to reservoir 204, such that at least one valve 228 may be in mechanical communication with tubing 218. In this manner, reservoir 204 may be in fluidic communication at least one valve 228, via at least one aperture (e.g. a bulkhead fitting) 226 disposed about at least a portion of a base of reservoir 204.

In addition, as shown in FIG. 10, in conjunction with FIG. 11, in this embodiment, the at least one cleaning agent may be disposed within reservoir 204 via at least one opening 210. The at least one opening 210 may be disposed about at least a portion of a top surface of reservoir 204. The at least one opening 210 may be disposed about at least a portion of a top surface of reservoir 204. In this manner, as shown in FIGS. 10-18, reservoir 204 may comprise at least one cap 242 configured to temporarily couple (e.g., male-to-female threading, adhesives, nails, clasps, and/or steps) to at least one opening 210. In this embodiment, an inner perimeter of at least one cap 242 may be configured to abut an outer perimeter of at least one opening 210, such that the inner perimeter of the at least one cap 242 encompasses at least one opening 210, forming a water tight seal and/or preventing the at least one cleaning agent from escaping reservoir 204. In addition, in some embodiments, at least one cap 242 may comprise at least one hole disposed about at least one portion of a top surface of at least one cap 242, in which the at least one hole may extend through the top surface of the at least one cap 242. Accordingly, in these other embodiments, the at least one hole may be configured to allow the transfer of at least one air particle through reservoir 204 to an external environment and/or vice versa, allowing for the case of flow of the at least one cleaning agent through at least one aperture 226. Moreover, the at least one hole may comprise a size and/or shape configured to retain the at least one cleaning agent within reservoir 204. Furthermore, in these other embodiments, the at least one hole may comprise a mesh, preventing any foreign particulate and/or external moisture and/or external liquid may enter reservoir 204, while at least one cap 242 is temporarily coupled to at least one opening 210. In some embodiments, reservoir 204 may comprise a plurality of measurement markings, such that the total amount of cleaning agent within reservoir 204 may be determined by at least one user, via a visual stimulus and/or a tactile stimulus.

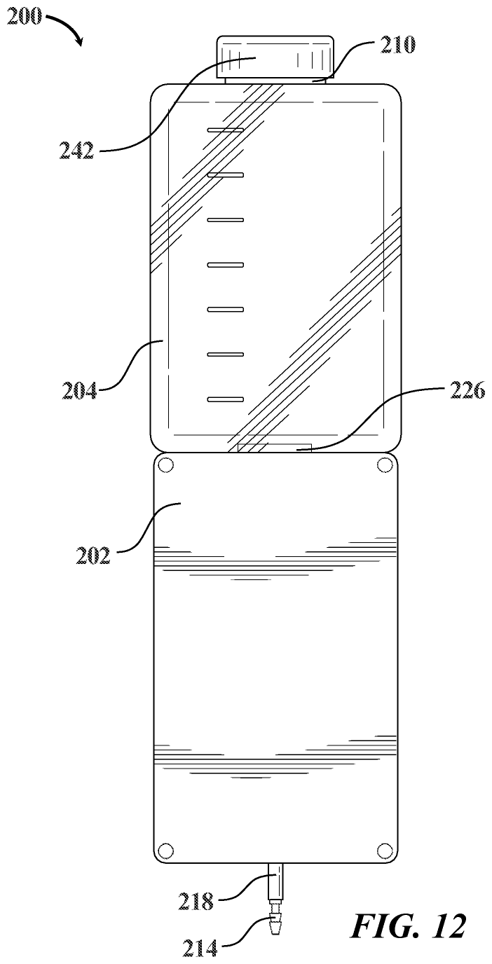

As shown in FIG. 11 and FIG. 12, in conjunction with FIG. 17, housing 202 may comprise at least one chamber, such that at least one valve 228 may be disposed in the at least one chamber of housing 202. In addition, at least one reservoir connector 222 (e.g., a at least one bulkhead fitting) may be disposed within the at least one chamber. As such, in this embodiment, at least one reservoir connector 222 may be in fluidic communication with at least one valve 228, such that at least one reservoir connector 222 may release the at least one cleaning agent from reservoir 204 to at least one valve 228 at a predetermined amount and/or a predetermined rate (e.g., at least 60 ml (0.25 cups) per day, week, and/or month). For example, in some embodiments, at least one reservoir valve connector 222 may be configured to vary the predetermined amount and/or the predetermined rate of release of the at least one cleaning solution based on an amount of occlusion found in the at least conduit line and/or the schematics of the at least one conduit line associated with the HVAC system, refrigeration system, and/or septic system. Accordingly, in an embodiment, when the at least one cleaning agent is received by at least one valve 228, at least one valve 228 may be configured to release the at least one cleaning agent into the at least one conduit line.

Additionally, as shown in FIG. 11 and FIG. 12, in conjunction with FIG. 17, in an embodiment, a tubing 218 may be disposed within the at least one chamber of housing, such that one end of tubing 218 may be in mechanical communication and/or fluidic communication with reservoir 204, at least one valve 228, and/or at least one reservoir connector 222 (e.g., a bulkhead fitting). In this manner, in this embodiment, the opposite end of tubing 218 may be in mechanical communication and/or fluidic communication with a first coupling mechanism (e.g., a tubing nipple and/or a tubing barb) 214. First coupling mechanism 214 may be configured to mechanically couple and/or fluidly couple with at least one conduit line, such that when the at least one cleaning agent is released from the conduit line sanitation apparatus, via reservoir 204 and/or at least one reservoir connector 222, the at least one cleaning agent may enter the at least one conduit line, via first coupling mechanism 214. In this manner, in this embodiment, at least one reservoir connector 222 (e.g., a bulkhead fitting) may be configured to be in fluidic communication and/or mechanical communication with tubing 218, via a second coupling mechanism 236 (e.g., a tubing nipple, a tubing barb, a hose nipple, and/or a hose barb).

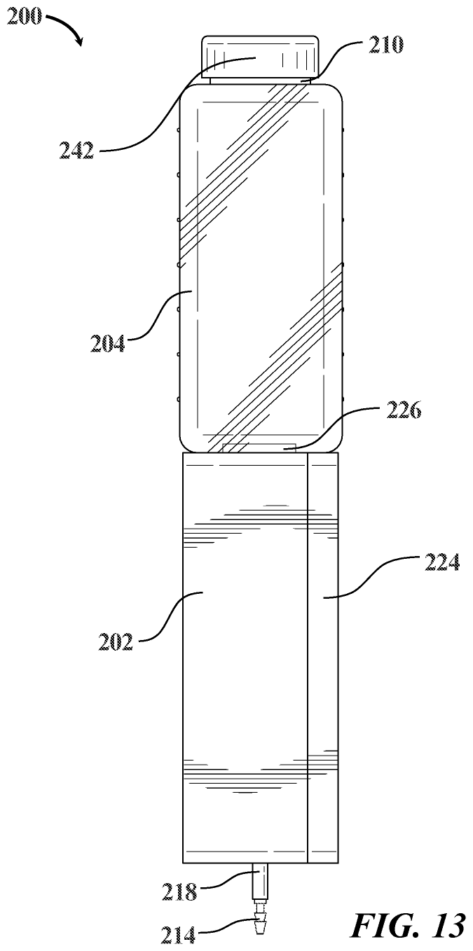

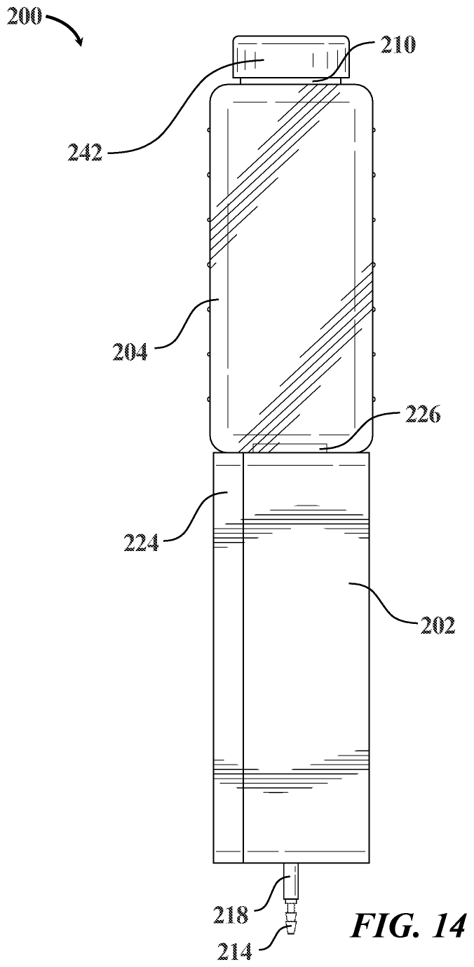

FIG. 13 and FIG. 14 depict a side perspective of conduit line sanitation apparatus 200, according to an embodiment of the present disclosure. In an embodiment, housing 202 may comprise a lid 224 disposed about at least a portion of the front side of housing 202. In this manner, lid 224 may be configured to be removably affixed to the front side of housing 202, such that when lid 224 is removed, the at least one chamber of housing 202 may be exposed. In this manner, lid 224 may be mechanically coupled to housing 202, via at least one connector 240 (e.g., a screw, a nail, and/or an adhesive).

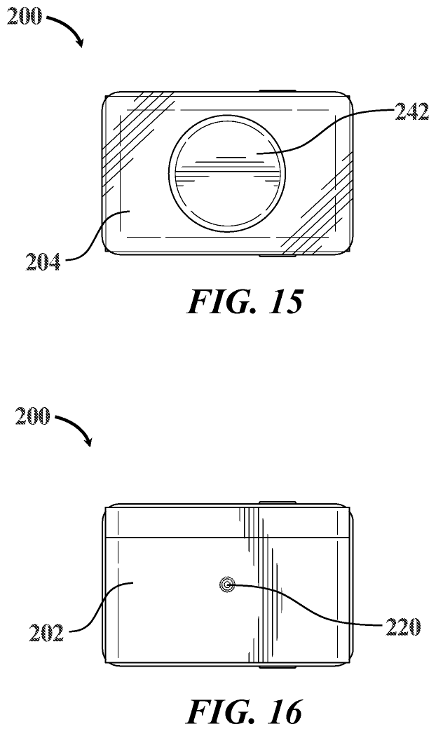

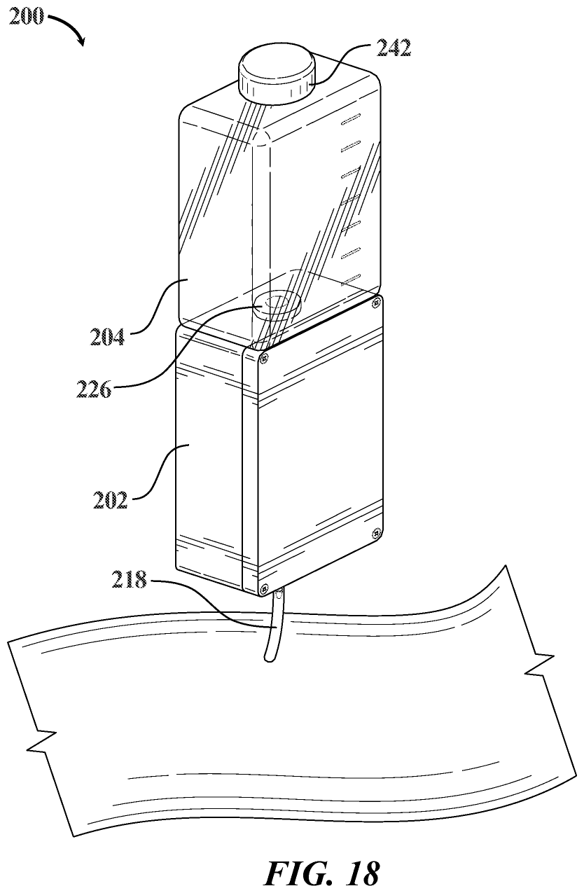

Additionally, as shown in FIG. 15 and FIG. 16, in conjunction with FIG. 17 and FIG. 18, as stated above, reservoir 204 may comprise at least one opening 210 disposed about the top surface of reservoir 204. In this manner, the at least one cleaning agent may be disposed and/or poured into reservoir 204, via the at least one opening 210. Additionally, as shown in FIG. 16, housing 202 of conduit line sanitation apparatus 200 may comprise at least one orifice 220, such that tubing 218 may be disposed through at least one orifice 220. As such, an inner perimeter of at least one orifice 220 may be configured to abut an outer perimeter of tubing 218, such that the inner perimeter of at least one orifice 220 may encompass the outer perimeter of tubing 218, forming a water tight seal. In this manner, in this embodiment, tubing 218 may be disposed both within the at least one chamber and outside the housing 202, via at least one orifice 220.

In an embodiment, as shown in FIG. 17, in conjunction with FIGS. 10-16 and FIG. 18, conduit line sanitation apparatus may further comprise a siphon 230 (e.g., a Pythagorean cup and/or Pythagorean container, and/or the like) in mechanical communication with tubing 218. In this manner, siphon 230 may be disposed about at least a portion of tubing 218 subsequent to integrated at least one valve 228. As such, siphon 230 may comprise at least one chamber (not shown) in fluidic communication with tubing 218. In this embodiment, the at least one chamber of siphon 230 may be configured to receive a predetermined amount of the at least one cleaning agent, such that when the predetermined amount of the at least one cleaning agent has been met, the at least one chamber of siphon 230 may be configured to release the at least one cleaning agent into tubing 218 toward the at least one conduit line of the HVAC system, refrigeration system, and/or septic system.

As such, based on the predetermined flow rate allowed by the positioning of the at least one valve 228, the rate of receival within the at least one chamber of siphon 230 and subsequently the rate of release into tubing 218 may be increased and/or decreased, based on the positioning of the at least one valve 228 (e.g., open position, closed position, and/or any position between the open position and the closed position). As such, the rate of release of the at least one cleaning agent may be slowed based on the exact specifications provided by the HVAC system, the refrigeration system, and/or the septic system connected to the at least one conduit line, via the at least one valve 228 and siphon 230. Accordingly, an appropriate amount of the at least one cleaning agent may be disposed within the at least one conduit line at a predetermined time, via the at least one chamber of siphon 230 and/or the at least one valve 228, such that the occlusion found within the at least one conduit line of the HVAC systems, the refrigeration systems, and/or the septic systems may be eliminated and/or preventing, freeing the at least one conduit line of any occlusion (i.e., blockage and/or buildup) (e.g., algae buildup, mildew buildup, and/or mold buildup).

In addition, shown in FIG. 17, in an embodiment, siphon 230 may be in mechanical communication and/or fluidic communication with tubing 218, via at least one siphon tubing nipple/barb 236, such that a water tight seal may be formed between siphon 230 and tubing 218. As such, when siphon 230 receives the at least one cleaning agent the at the designated flow rate, as determined by the at least one valve, the at least one cleaning agent may pass into siphon 230 without loss of any cleaning agent.

Additionally, in an embodiment, conduit line sanitation apparatus 200 may comprise at least one fluid sensor, such that the amount of the at least one cleaning agent disposed within reservoir 204, tubing 218, and/or the at least one valve 228 may be determined. As such, in this embodiment, when the at least one fluid sensor determines that the fluid flow rate and/or the total amount of the at least one cleaning agent is too great as compared to a predetermined fluid flow rate and/or predetermined amount released, the at least one fluid sensor may be configured to transmit at least one electrical signal to the processor. In this manner, subsequent to receiving the at least one electrical signal, the processor may be configured to transmit at least one electrical signal to a display device associated with the computing device. Accordingly, the display device may be configured to transmit a notification indicative of translating the at least one valve 228 toward the closed position, via the at least one user.

In this same manner, when the at least one fluid sensor determines that the fluid flow rate and/or the total amount of the at least one cleaning agent is too low as compared to a predetermined fluid flow rate and/or predetermined amount released, the at least one fluid sensor may be configured to transmit at least one alternative electrical signal to the processor. In this embodiment, subsequent to receiving the at least one alternative electrical signal, the processor may be configured to transmit at least one electrical signal to the display device, such that the display device associated with the computing device may transmit a notification indicative of translating the at least one valve 228 toward the open position, via the at least one user. In this embodiment, once the appropriate positioning of the at least one valve 228 has been achieved (e.g., translation toward the open position and/or the closed position), the display device may be configured to transmit a notification indicative of a successful translation of the at least one valve 228. As such, if the appropriate position of the at least one valve 228 has not been achieved, the display device may be configured to transmit a notification indicative of the at least one valve 228 requiring additional translation toward the open position and/or the closed position.

Moreover, in an embodiment, at least one fluid sensor may be configured to transmit an electrical signal to the processor associated with conduit line sanitation apparatus 200 once a predetermined amount and/or level is detected within reservoir 204 (e.g., at most ¼^{th} of the reservoir filled with the at least one cleaning agent). As such, in this embodiment, when the predetermined amount and/or level of is detected, the at least one fluid sensor may be configured to transmit a signal to a display device associated with a computing device communicatively coupled to conduit line sanitation apparatus 200. In addition, in this embodiment, once the electrical signal is received by the computing device, the display device may be configured to transmit a signal to the at least one user indicative of a low amount of cleaning agent remaining within reservoir 204 and/or indicative of having to refill reservoir 204.

Furthermore, as shown in FIG. 19, in conjunction with FIG. 10, in an embodiment, conduit line sanitation apparatus 200 may comprise a reservoir casing 134. Reservoir casing 134 may be configured to encompass reservoir 204, such that the base of reservoir casing 134 may abut the top surface of housing 202. In this manner, reservoir casing 134 may comprise a plurality of measurement markings, such that the total amount of cleaning agent within reservoir 104 may be determined by at least one user, a visual stimulus and/or a tactile stimulus may also comprise an opening, such that when reservoir casing 134 encompasses reservoir 204, the plurality of measurement marking may be seen. In some embodiments, the plurality of measurement markings may be disposed about at least one portion of reservoir casing 134, such that the total amount of cleaning agent within reservoir 204 may be determined by at least one user, via a visual stimulus and/or a tactile stimulus. In addition, in some embodiments, reservoir casing 134 may be affixed to housing 202, such that reservoir 204 may be encapsulated by reservoir casing 134 and/or housing 202. In these other embodiments, reservoir casing 134 may comprise at least one additional aperture, such that the at least one opening 210 of reservoir 204 may be exposed, allowing the disposal of the at least one cleaning agent into reservoir 204.

### Method of Use

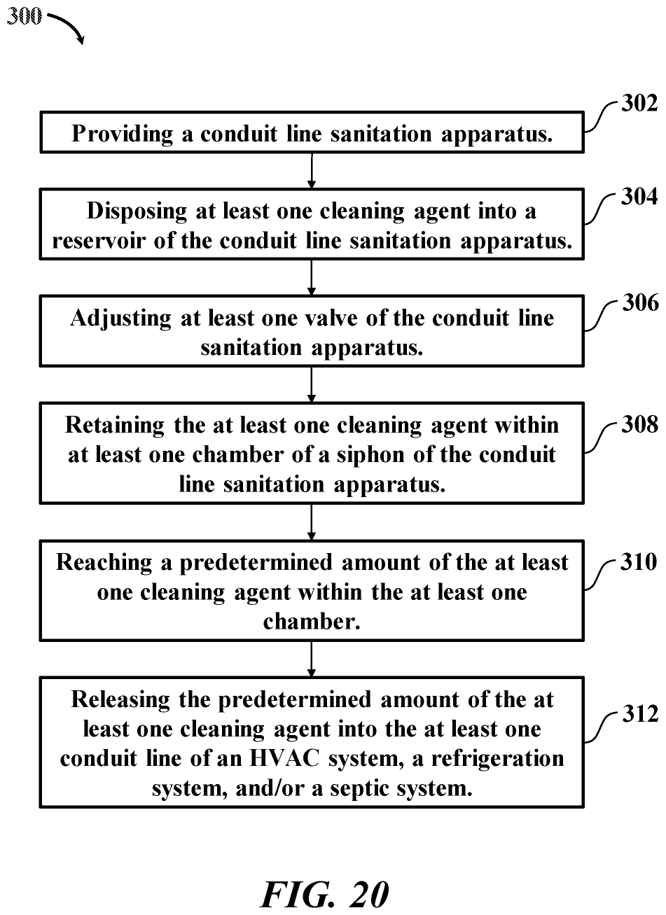

FIG. 20, in conjunction with FIGS. 1-19, depicts a flow chart providing the steps of a method 300 of sanitizing at least one conduit line (e.g., condensate line) of an HVAC system, refrigeration system, and/or septic system, via a conduit line sanitation apparatus 100, 200, comprising a housing 102, 202 and/or a reservoir 104, 204. The steps delineated in FIG. 20 are merely exemplary of an order of sanitizing at least one conduit line, via a conduit line sanitation apparatus 100, 200. The steps may be carried out in another order, with or without additional steps included therein.

As shown in FIG. 20, in conjunction with FIGS. 1-19, in an embodiment, the method 300 begins at step 302, in which a conduit line sanitation apparatus 100, 200 comprising a housing 102, 202, and/or a reservoir 104, 204 may be provided. The next step, step 304, comprises disposing at least one cleaning agent into a reservoir of the conduit line sanitation apparatus. Additionally, in this embodiment, reservoir 104, 204 of conduit line sanitation apparatus 100, 200 may be in mechanical communication and/or fluidic communication with that least one aperture (bulkhead fitting) 126, 226. Subsequently, at step 306, at least one valve 106, 228 of conduit line sanitation apparatus 100, 200 may be adjusted to provide the predetermined flow rate of the at least one cleaning agent through conduit line sanitation apparatus 100, 200 at each respective predetermined time interval. In this embodiment, the conduit line sanitation apparatus 200 comprising the passively fed valve may proceed to steps 308 and 310, the conduit line sanitation apparatus 100 comprising the actively fed valve may proceed to step 312.

Furthermore, as shown in FIG. 20, in conjunction with FIGS. 1-19, in an embodiment, at step 308, siphon 230 of conduit line sanitation apparatus 200 may comprise at least one chamber, such that the at least one chamber may be configured to retain a predetermined amount of the at least one cleaning agent. Next, in this embodiment, at step 310, method 300 comprises reaching a predetermined amount of the at least one cleaning agent within the at least one chamber of siphon 230. Finally, at step 312, conduit line sanitation apparatus 100, 200 may be configured to release the predetermined amount of the at least one cleaning agent into the at least one conduit line of the HVAC system, refrigeration system, and/or septic system.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. An apparatus for optimized sanitation of at least one conduit line of a HVAC system, the apparatus comprising:
a housing comprising at least one compartment;
a reservoir configured to retain at least one cleaning agent;
a tubing disposed within the at least one compartment, the tubing being in mechanical communication, fluidic communication, or both, with the reservoir and the at least one conduit line;
at least one valve disposed about at least a portion of the tubing, the at least one valve being in mechanical communication with the tubing; and
wherein the at least one valve is configured to release a predetermined amount of the at least one cleaning agent at a predetermined timed interval through the tubing into the at least one conduit line.

2. The apparatus of claim 1, wherein subsequent to the at least one valve releasing the predetermined amount of the at least one cleaning agent, the conduit line of the HVAC system is sanitized.

3. The apparatus of claim 1, further comprising a siphon in mechanical communication, fluidic communication, or both with the tubing.

4. The apparatus of claim 3, wherein the siphon comprises at least one chamber.

5. The apparatus of claim 4, wherein the at least one chamber is configured to retain the at least one cleaning agent until a predetermined amount of the at least one cleaning agent is retained by the at least one chamber, whereby the at least one cleaning agent is released from the siphon into the at least one conduit line.

6. The apparatus of claim 3, wherein the siphon is a Pythagorean cup, Pythagorean container, or both.

7. The apparatus of claim 1, wherein the at least one valve is motorized.

8. The apparatus of claim 7, wherein the at least one valve comprises at least one actuator configured to translate the valve from an open position to a closed position, a closed position to an open position, or both.

9. The apparatus of claim 8, further comprising at least one timer, the at least one timer being communicatively coupled to the at least one motorized valve.

10. The apparatus of claim 9, wherein the at least one timer is programmable, whereby the at least one timer is configured to receive at least one timed interval input, via a user-interface associated with the at least one timer.

11. The apparatus of claim 10, wherein subsequent to reaching at least one programmed timed interval, the timer is configured to transmit an electrical signal to the at least one actuator of the at least one motorized valve, whereby the at least one motorized valve is translated from a closed position to an open position, thereby releasing the predetermined amount of the at least one cleaning agent into the conduit line.

12. The apparatus of claim 11, wherein subsequent to the release of the predetermined amount of the at least one cleaning agent into the conduit line, the at least one timer is configured to cease transmission of the electrical signal to the at least one actuator of the at least one motorized valve, whereby the at least one motorized valve is translated from the open position to the closed position, thereby inhibiting the release of the at least one cleaning agent into the conduit line.

13. The apparatus of claim 10, further comprising a protective temporarily affixed to the user-interface of the at least one programmable timer, the protective cover being configured to encompass the user-interface.

14. A method for optimizing sanitation of at least one conduit line of a HVAC system, the method comprising:
disposing at least one cleaning agent into a reservoir in mechanical communication, fluidic communication, or both with a tubing, wherein the tubing in in mechanical communication, fluidic communication, or both with the at least one conduit line;
adjusting at least one valve disposed about at least a portion of the tubing, wherein the at least one valve is in mechanical communication with the tubing;
releasing a predetermined amount of the at least one cleaning agent at a predetermined interval based on the at least one adjusted valve into the at least one conduit line; and
wherein the incorporation of the at least one cleaning agent to the conduit line thereof optimizes a sanitizing reaction within the at least one conduit line.

15. The method of claim 14, wherein the tubing is in mechanical communication, fluidic communication, or both with a siphon.

16. The method of claim 15, wherein the siphon comprises at least one chamber.

17. The method of claim 16, further comprising the step of, filling the at least one cleaning agent within the at least one chamber of the siphon until a predetermined amount of the at least one cleaning agent is retained by the at least one chamber, whereby the at least one chamber is configured to release at least one cleaning agent from the siphon into the at least one conduit line.

18. The method of claim 17, wherein the siphon is a Pythagorean cup, Pythagorean container, or both.

19. The method of claim 14, wherein the at least one valve is motorized.

20. The method of claim 19, wherein the step of adjusting the at least one valve further comprises the step of, translating the at least one valve from an open position to a closed position, a closed position to an open position, or both.
